(19) United States
(12) Patent Application Publication
(10) Pub. No.: US 2026/0203004 A1
(43) Pub. Date: Jul. 16, 2026

(54) NON-TRANSITORY COMPUTER READABLE STORAGE MEDIUM

(71) Applicant: BROTHER KOGYO KABUSHIKI KAISHA, Nagoya (JP)

(72) Inventors: Yoshito HOSOMIZO, Konan (JP); Kenju NARITA, Nagoya (JP); Airi EGUCHI, Ichinomiya (JP)

(21) Appl. No.: 19/565,996

(22) Filed: Mar. 13, 2026

Related U.S. Application Data
(63) Continuation of application No. PCT/JP2024/045154, filed on Dec. 20, 2024.

(30) Foreign Application Priority Data
Feb. 12, 2024 (JP) 2024-019058

(51) Int. Cl. G06F 3/12

(52) U.S. Cl. CPC G06F 3/1297; G06F 3/1205; G06F 3/1228; G06F 3/1248

(57) ABSTRACT

A non-transitory computer readable storage medium storing a support program executable by a computer of an information processing device and corresponding to a printer, the information processing device being mounted with an operating system having a general-purpose printing program. The support program includes: determining a compression condition based on at least one of a print setting corresponding to a print instruction and a capability of the printer; instructing the general-purpose printing program to perform compression under the compression condition; acquiring intermediate data representing an image to be printed according to the print instruction, in which the intermediate data subjected to a compression process by the general-purpose printing program under the compression condition instructed in the instruction process is acquired; and causing the printer to perform printing based on print data generated from the intermediate data.

### REFERENCE TO RELATED APPLICATIONS

This is a continuation application of International Application No. PCT/JP2024/045154 filed on December 20, 2024, which claims priority from Japanese Patent Application No. 2024-019058 filed on February 12, 2024. The entire contents of the aforementioned applications are incorporated herein by reference.

### BACKGROUND ART

In recent years, a technique has been put into practical use in which a printer is controlled by an OS-standard general-purpose printing program that is part of the operating system (OS), without using a printer driver provided by a printer vendor. With this technique, when the OS detects a printer, association with the OS-standard general-purpose printing program is performed, and thereafter, when a print instruction for the printer is received, the OS-standard general-purpose printing program generates print data without using the printer driver provided by the printer vendor, making it possible to print using the OS-standard general-purpose printing program.

For example, a related art discloses a technique related to an OS-standard general-purpose printing program. The related art discloses a support program that supports a general-purpose printing program, which determines whether compression is necessary based on print settings and the like, and compresses raster data if the compression is necessary.

The related art discloses a technique in which the support program compresses data to be transmitted to a printer, but if the support program implements a compression function, the processing of the support program becomes complicated and the load on the support program may become heavy.

### SUMMARY

A non-transitory computer readable storage medium storing a support program, for solving the above-described problems, the support program is executable by a computer of an information processing device and corresponding to a printer connected to the information processing device. The information processing device is mounted with an operating system having a general-purpose printing program. The support program causes the computer to execute: when a print instruction that is output from an application program incorporated in the information processing device and that instructs the general-purpose printing program to cause the printer to print an image is received, a determination process of determining a compression condition based on at least one of a print setting corresponding to the print instruction and a capability of the printer; an instruction process of instructing the general-purpose printing program to perform compression under the compression condition determined in the determination process; an acquisition process of acquiring intermediate data representing the image to be printed according to the print instruction, in which the intermediate data subjected to a compression process by the general-purpose printing program under the compression condition instructed in the instruction process is acquired; and a print process of causing the printer to perform printing based on print data generated from the intermediate data acquired in the acquisition process.

### BRIEF DESCRIPTION OF THE DRAWINGS

FIG. 1 is a block diagram showing an outline of an electrical configuration of a PC.

FIG. 2 is a sequence diagram showing an example of a print setting procedure.

FIG. 3 is a diagram illustrating an example of a compression condition.

FIG. 4 is a flowchart illustrating an example of a procedure for generating print data.

### DESCRIPTION

Hereinafter, a personal computer (hereinafter, referred to as a "PC") that uses a support program according to the present aspect will be described in detail with reference to the accompanying drawings. The present description discloses a support program to be executed on the PC.

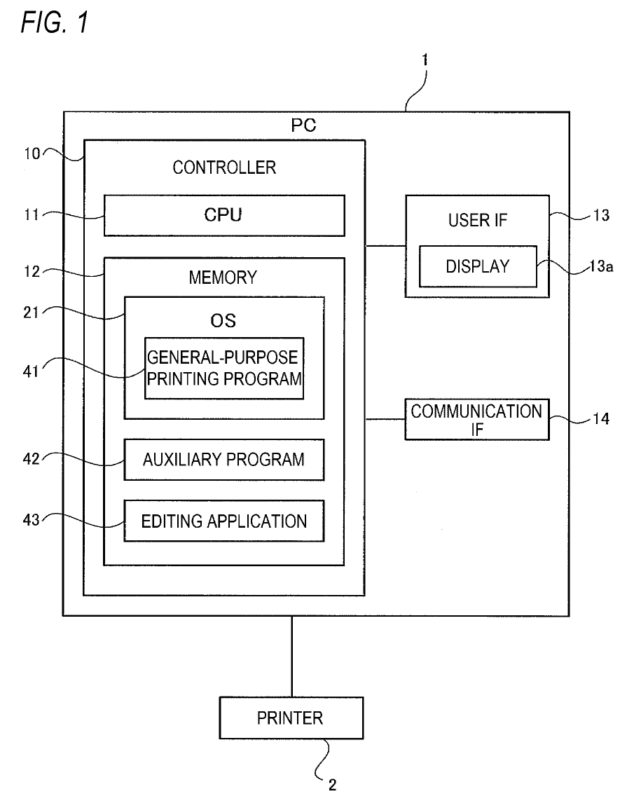

As illustrated in FIG. 1, a PC 1 according to the present aspect includes a controller 10 including a CPU 11 and a memory 12. The PC 1 is an example of the "information processing device". The CPU 11 is an example of the "computer". The PC 1 includes a user interface (hereinafter, referred to as a "user IF") 13, and a communication interface (hereinafter, referred to as a "communication IF") 14 that are electrically connected to the controller 10. The controller 10 in FIG. 1 is a collective term for hardware and software used to control the PC 1, and does not necessarily represent a single piece of hardware actually present in the PC 1.

The CPU 11 of the PC 1 is configured to execute various types of processes, in accordance with a program read from the memory 12 and based on a user operation. The memory 12 stores various programs and various data. The memory 12 is used as a work area in a case where various types of processes are executed. A buffer provided in the CPU 11 is also an example of the memory. An example of the memory 12 is not limited to a ROM, a RAM, a HDD, and the like built into the PC 1, but may also be a storage medium that can be read and written by the CPU 11, for example, a recording medium such as a CD-ROM, and a DVD-ROM.

The user IF 13 includes a display 13a which is hardware that displays a screen for reporting information to a user, and hardware that receives an operation from the user. The user IF 13 may be a combination of the display 13a capable of displaying information and a mouse, a keyboard, or the like having an input receiving function, or may be a touch panel having the functions of the display 13a and the input receiving function.

The communication IF 14 includes hardware for communicating with an external device such as a printer 2. Communication standards of the communication IF 14 include Ethernet (registered trademark), Wi-Fi (registered trademark), USB, and the like. The PC 1 may be connectable to the Internet via the communication IF 14. The PC 1 may include a plurality of communication IFs 14 corresponding to a plurality of communication standards.

As shown in FIG. 1, the memory 12 of the PC 1 stores various programs and various data including an operating system (hereinafter, referred to as "OS") 21 including a general-purpose printing program 41, an auxiliary program 42, and an editing application 43. The auxiliary program 42 is an example of the "support program". The editing application 43 is an example of the "application program".

The OS 21 is a multitasking OS that can process a plurality of tasks in parallel by managing and switching between the plurality of tasks. The OS 21 is, for example, Windows (registered trademark), macOS (registered trademark), Linux (registered trademark), iOS (registered trademark), or Android (registered trademark).

The OS 21 includes the general-purpose printing program 41. The general-purpose printing program 41 is an OS-standard program prepared by a vendor of the OS 21 and provided as a part of the OS 21. That is, the PC 1 is equipped with the OS 21 having the general-purpose printing program 41. The general-purpose printing program 41 is not configured to use a printer driver specific to each printer.

The general-purpose printing program 41 is a program having a function of causing printers of a plurality of types of models respectively provided by a plurality of vendors to execute printing based on an instruction of a user. The general-purpose printing program 41 supports a general-purpose function that enable printing to be performed on many printers. Unlike a printer driver specific to each printer, the general-purpose printing program 41 does not support functions specific to each printer or printer driver, in particular, functions that require complex processes.

The general-purpose printing program 41 is a program that includes a function of receiving image data designated as a printing target by a print instruction output from various applications based on an instruction of a user, and generating intermediate data based on the image data. The intermediate data is, for example, XPS data. The general-purpose printing program 41 further has a function of generating print data in a format that can be used for printing on various printers, based on the intermediate data. The print data is, for example, PWG Raster data or PDF data. The general-purpose printing program 41 has a function of transmitting the generated print data to a printer designated as a device to execute printing, via a communication function of the OS 21.

The auxiliary program 42 is a program or a group of programs that executes processes based on an instruction from the OS 21 in conjunction with the process of the general-purpose printing program 41, and is a program that supports the control of target hardware. The auxiliary program 42 of the present aspect corresponds to a model of the printer 2 connected to the PC 1, and is provided by, for example, the vendor of the printer 2. The general-purpose printing program 41 activates the auxiliary program 42 compatible with the printer 2 when the printer 2 is selected as a device for executing printing, when an instruction for detailed print settings is received in a state where the printer 2 is selected, when an instruction for causing the printer 2 to execute printing is received, or the like. The auxiliary program 42 is called, for example, a print support application (abbreviated as PSA) or a hardware support application (abbreviated as HSA).

The auxiliary program 42 may be a combination of a plurality of programs each of which receives an execution command, or may be one single program that can execute different processes in response to commands. Further, the auxiliary program may be a program prepared for each type of printer by the vendor of the printer. For example, an auxiliary program for an inkjet printer and an auxiliary program for a laser printer may be prepared separately. The auxiliary program may be prepared not only for each type of printer, but also for each model of printer or each series of printer models.

For example, when a new printer is connected to the PC 1, the OS 21 of the PC 1 can download an appropriate auxiliary program from a server or the like of the vendor of the printer or storage specified by OS 21 according to the type or model of the connected printer and incorporate the auxiliary program into the PC 1. The OS 21 stores identification information of the incorporated auxiliary program in the memory 12 in association with printer information of the newly connected printer.

The editing application 43 is, for example, a program for creating and editing image data and document data. The editing application 43 may be, for example, Microsoft Word (registered trademark) or PowerPoint (registered trademark) manufactured by Microsoft (registered trademark), or may be a program provided by the vendor of the printer 2. The editing application 43 can receive, via the user IF 13, a print execution instruction to cause the printer 2 to execute printing, for example. The editing application 43 is not limited to a program for creating or editing data, and may be a program that has a function of receiving a display instruction or a print instruction for various kinds of information such as map information or a web page in response to user requests.

The PC 1 of the present aspect is connected to the printer 2 via the communication IF 14 as shown in FIG. 1. The printer 2 is a device that has at least a printing function and a communication function. For example, when receiving print data from the PC 1 or the like, the printer 2 can execute printing based on the received print data. The printer 2 may be a device capable of color printing, or may be a device capable of only monochrome printing.

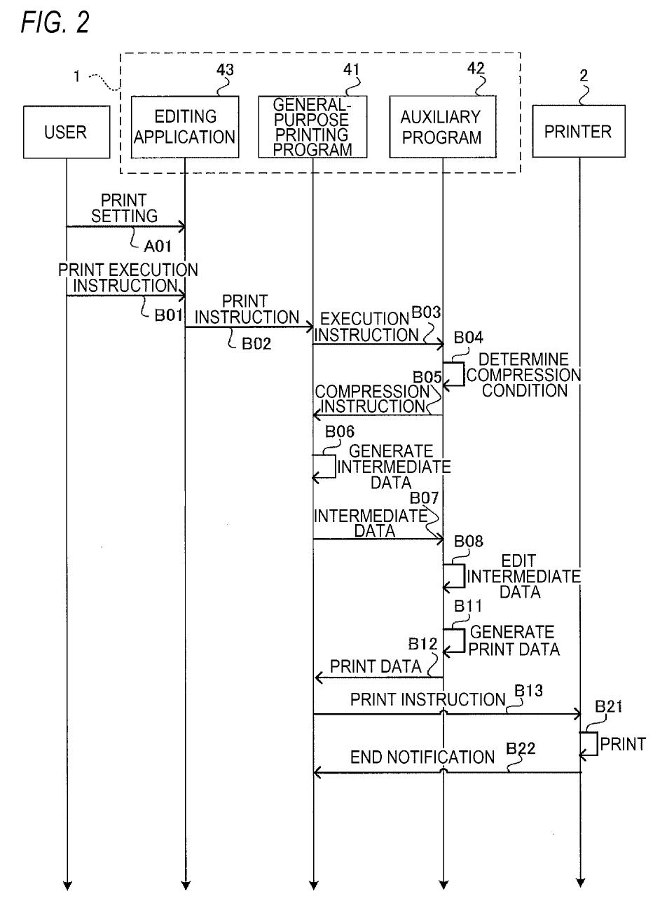

Next, the procedure of a process related to printing by the printer 2 in the PC 1 of the present aspect will be described based on the sequence of FIG. 2. Each process other than the operation of a user in the present aspect basically indicates a process of the CPU 11 according to instructions written in a program such as the auxiliary program 42. In the present specification, various processes performed by the controller 10 or the CPU 11 according to programs such as the auxiliary program 42, the general-purpose printing program 41, and the OS 21 may be described as if each program were performing the various processes independently for convenience. The process executed by the CPU 11 also includes control of hardware using API of the OS 21. In the present specification, a detail description of the OS 21 is omitted, and an operation of each program is described. The term "acquisition" is used as a concept indicating that a request is not essential.

After determining an image to be printed and print settings in the printer 2 (A01), a user inputs an instruction for print execution into the editing application 43 (B01). For example, the editing application 43 requests the general-purpose printing program 41 to display a print setting screen. The print setting screen is, for example, a screen for receiving user instructions for various print settings that can be received by the general-purpose printing program 41. The print setting screen may have a region where information specified by the auxiliary program 42 can be displayed. The general-purpose printing program 41 receives, via the print setting screen, a selection instruction to select the printer 2 as a device to perform printing, various parameters of print settings, print selection and the like, and passes the received information to the editing application 43. The editing application 43 may display the print setting screen to receive various settings.

For example, in a case where a selection instruction to select the printer 2 as the device to perform printing is received on the print setting screen, or in a case where selection of printing is received in a state where the printer 2 is selected as the device to perform printing, the general-purpose printing program 41 receives from the editing application 43 information indicating that the printer 2 is selected together with the print instruction (B02).

The general-purpose printing program 41 outputs an execution instruction to the auxiliary program 42 corresponding to the printer 2, and activates the auxiliary program 42 (B03).

The activated auxiliary program 42 determines the compression condition based on at least one of the print settings corresponding to the print instruction and the capabilities of the selected printer (B04). The compression condition is a condition under which the general-purpose printing program 41 performs a compression process on the intermediate data representing an image to be printed. B04 is an example of the "determination process". The auxiliary program 42 may determine whether to compress the intermediate data according to the compression condition, or may determine a degree of compression of the intermediate data, that is, the compression rate. A compression condition indicating whether to perform compression is an example of the "first condition". A compression condition indicating the compression rate is an example of the "second condition".

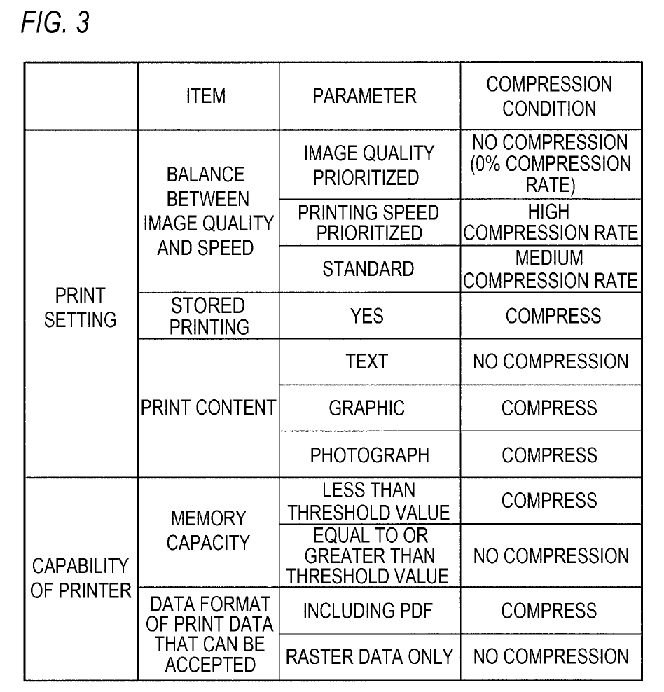

The print settings are, for example, print settings received from the general-purpose printing program 41 when the auxiliary program 42 is activated from the general-purpose printing program 41 in B03. The print settings may be print settings received via the print setting screen after the auxiliary program 42 is activated. In the auxiliary program 42, the compression condition is set in advance for each item or parameter of the print setting, as shown in FIG. 3, for example.

The print settings may include, for example, an item regarding the balance between image quality and speed. Parameters that can be set in this item include, for example, a parameter indicating that image quality is prioritized, a parameter indicating that printing speed is prioritized, and a parameter indicating a standard that balances image quality and speed. When the data is compressed, there is a possibility that the image quality of the printing result deteriorates. Therefore, when a parameter indicating that image quality is prioritized is set in the print settings, the compression condition may be set to no compression. When the compression condition indicates a compression rate, the compression condition that indicates a higher compression rate may be set in the order of, for example, the parameter indicating that printing speed is prioritized, the parameter that indicates the standard, and the parameter indicating that image quality is prioritized. The compression rate may be 0%, that is, no compression.

The smaller the data size, the shorter the data transfer time tends to be. Therefore, when a parameter indicating that image quality is prioritized is set in the print settings, the compression condition may be set to indicate a first compression rate, and when a parameter indicating that speed is prioritized is set in the print settings, the compression condition may be set to indicate a second compression rate that is higher than the first compression rate. It should be noted that when a parameter indicating the standard is set in the print settings, the compression condition may be set to indicate a third compression rate between the first compression rate and the second compression rate.

The printer model includes a model corresponding to stored printing. The stored printing is a printing method in which the printer does not immediately start printing based on a received print job, but instead accumulates data based on the print data in the memory, and starts printing based on the data in response to a user operation via the user interface of the printer. If the printer 2 is a model that supports stored printing, the print setting screen can accept a setting as to whether stored printing is to be performed. The parameters that can be set for the stored printing may also include a password to be entered via the operation panel of the printer when printing the print data stored in the printer, and whether to perform the stored printing may be determined based on the presence or absence of the password.

In the case of stored printing, the print data transferred to the printer 2 is not immediately printed, but is stored in the memory of the printer 2, causing a memory load. Therefore, when a parameter for the stored printing is set in the print settings, the compression condition may be set to compress. The compression condition may be set such that a higher compression rate is indicated when the stored printing is performed than when the stored printing is not performed.

The print settings may include, for example, parameters that indicate the type of print content. The parameters that can be set for the type of print content include text, graphics, and photographs. For example, even if text is set as the type of print content, the text may be included as image data in the print target. When text image data is compressed, characters may become distorted. Therefore, when a parameter indicating that the type of print content is text is set in the print settings, the compression condition may be set to no compression. For example, if a parameter indicating that the type of print content is a graphic or a photograph is set in the print settings, the compression condition may be set to compress. When the type of print content is text, compression condition with a lower compression rate may be set compared to graphics or photographs.

Various parameters of the print setting used to determine compression conditions, such as parameters related to the balance between image quality and speed, parameters for stored printing, and parameters indicating the type of print content, may be parameters acquired from a general-purpose printing program, or may be unique parameters used independently by the auxiliary program 42.

The capability of the printer 2 can be determined based on, for example, the model name of the printer 2 and capability information that can be acquired from the printer 2. The capability information includes, for example, information on setting items that can be set as print settings and parameters that can be set for each setting item.

The auxiliary program 42 may acquire the capability information from the printer 2 via the general-purpose printing program 41, for example, when the printer 2 is selected on the print setting screen and the information is received from the general-purpose printing program 41, when the auxiliary program 42 is activated from the general-purpose printing program 41 in response to an instruction to execute printing, or when the compression conditions are determined. In this case, the general-purpose printing program 41 performs communication with the printer 2 via the OS 21, for example, by communication according to internet printing protocol (IPP).

Instead of making a request to the general-purpose printing program 41, the auxiliary program 42 may acquire the capability information directly from the printer 2 using, for example, a management information base (MIB). The capability information that the auxiliary program 42 can acquire from the printer 2 may include more information than the capability information acquired via the OS 21.

The capability information is information that is made up of a plurality of items or parameters that indicate the capabilities of the printer. The auxiliary program 42 may acquire all of the capability information, or may acquire only a part of the capability information of the printer 2 that is used to determine the compression conditions.

The capability information may include, for example, the memory capacity of the printer 2. The memory capacity may include the memory capacity of a memory built into the printer 2 as well as the memory capacity of a memory externally attached to the printer 2. If the memory capacity of the printer 2 is small, there is a high possibility that data for printing places a large load on the memory of the printer 2. Therefore, the compression condition when the memory capacity of the printer 2 is less than a first threshold value may be set to compress. The compression condition when the memory capacity of the printer 2 is equal to or greater than the first threshold value may be set to no compression or to a compression rate lower than the compression rate when the memory capacity is less than the first threshold value.

Further, the compression condition may be set such that the smaller the memory capacity, the higher the compression rate. By setting a higher compression rate as the memory capacity becomes smaller, it is expected that the memory load on the printer 2 due to the print data can be reduced.

The data format of print data that can be received by the printer 2 is determined in advance. The data format of the print data is, for example, raster data such as PWG Raster data, or PDF. The auxiliary program 42 stores, for example, the data format of data that can be received for each compatible model, and can determine the data format that can be received based on the model of the selected printer 2. The auxiliary program 42 may acquire the capability information including the data format of print data that can be received by the printer 2 from the printer 2 or the OS 21.

In PDF data, for an image, image data representing the image is embedded in the file. Therefore, the size of the print data can be reduced by compressing the image data. Therefore, when PDF data is included in the format of print data received by the printer 2, the compression condition may be set to compress. When the format of print data received by the printer 2 is raster data only, the compression condition may be set to no compression.

The image to be printed is converted by the auxiliary program 42 into print data that can be received by the printer 2. For example, if the only format of print data that can be received by the printer 2 is PWG Raster data, the auxiliary program 42 generates raster data based on the intermediate data. Therefore, even if the general-purpose printing program 41 compresses the intermediate data, the size of the final raster data is not affected. Therefore, when the format of the print data received by the selected printer 2 is raster data, the compression condition may be set to no compression.

The print settings and capability items and parameters that determine the compression condition may be other than those shown in FIG. 3, and may not include all of those shown in FIG. 3. The compression condition for each item and parameter may differ from those shown in FIG. 3.

The auxiliary program 42 determines the compression condition based on at least one item of the print settings and capabilities shown in FIG. 3, for example. The compression condition may be determined from a plurality of items, in which case the priority of each item may be determined in advance or may be set by the user. Further, the user may be able to set which items are used to determine the compression condition.

As shown in FIG. 2, the auxiliary program 42 instructs the general-purpose printing program 41 to perform compression under the determined compression condition (B05). B05 is an example of the "instruction process".

The general-purpose printing program 41 generates the intermediate data in response to an instruction from the auxiliary program 42 (B06). The general-purpose printing program 41 generates intermediate data by converting the format of the data to be printed into the format of the intermediate data based on the information acquired from the editing application 43. The data to be printed that is passed to the general-purpose printing program 41 by the editing application 43 can be of various types, and the general-purpose printing program 41 converts the data to be printed into intermediate data. The intermediate data is, for example, XPS data.

For example, if the compression condition determined by the auxiliary program 42 indicates compression, the general-purpose printing program 41 executes a compression process to compress the image data included in the data to be printed when generating the intermediate data. The compression process is performed by a compression method that is compatible with the selected printer 2. The compression method can be determined based on, for example, the capability information. When the compression condition indicates a compression rate, the general-purpose printing program 41 generates the intermediate data by compressing the image data included in the image to be printed based on the compression rate. The compression rate may be determined in advance in the general-purpose printing program 41 for each compression method supported by the printer 2, instead of being instructed by the auxiliary program 42. The general-purpose printing program 41 may perform the compression process after generating the intermediate data, or may generate the intermediate data and perform the compression process simultaneously.

For example, when the compression condition indicates no compression, the general-purpose printing program 41 generates the intermediate data without compressing the image data included in the image to be printed.

The general-purpose printing program 41 passes the generated intermediate data to the auxiliary program 42 (B07). The auxiliary program 42 can acquire the intermediate data compressed by the general-purpose printing program 41 according to the compression condition determined by the auxiliary program 42 in B04. When the compression condition is determined to be no compression or the compression rate is determined to be 0% in B04, the auxiliary program 42 acquires uncompressed intermediate data from the general-purpose printing program 41 in B07. B07 is an example of the "acquisition process".

The auxiliary program 42 can edit the intermediate data or information on the print setting received from the general-purpose printing program 41 as necessary (B08).

The auxiliary program 42 generates print data, which is PDL data, based on the intermediate data (B11). The print data generated in B11 may be in any format that can be printed by the printer 2.

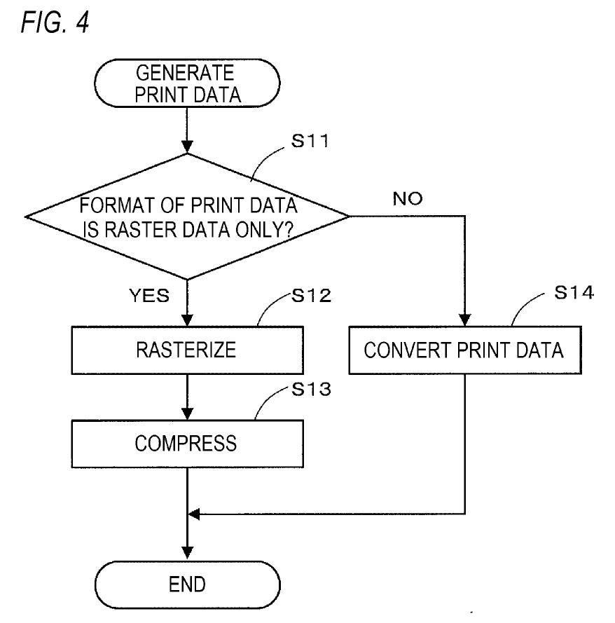

A procedure for generating print data will be described with reference to the flowchart of FIG. 4. The CPU 11 executing the auxiliary program 42 determines whether the format of print data received by the printer 2 is raster data only (S11).

When the data format of the print data received by the printer 2 is raster data only (S11: YES), the CPU 11 generates print data by rasterizing the intermediate data (S12) and compressing the data (S13), and then ends the process. The CPU11 may perform the rasterization and compression processes at the same time.

The CPU11 that executes the auxiliary program 42 performs the compression process using a compression method compatible with the selected printer 2. The compression method may be included in the capability information acquired from the printer 2, or may be stored by the auxiliary program 42 for each compatible model. As a result, if the data to be printed is not compressed by the general-purpose printing program 41, the data is compressed by the auxiliary program 42 as it is rasterized, thereby avoiding duplication of the compression process.

For example, when the data format of the print data received by the printer 2 is not only raster data (S11: NO), the CPU 11 converts the intermediate data into the print data (S14). That is, the CPU 11 generates the print data without rasterizing and compressing the intermediate data. For example, when the data format of the print data received by printer 2 is PDF and general-purpose printing program 41 generates the intermediate data by compressing image data as XPS data, the auxiliary program 42 converts the intermediate data into PDF data including the compressed image data and generates the print data.

Referring back to FIG. 2, the auxiliary program 42 passes the generated print data to the general-purpose printing program 41, and instructs the general-purpose printing program 41 to transmit the print data (B12). The general-purpose printing program 41 transmits the print data and the print command to the printer 2 using, for example, IPP-compliant communication (B13). The process of B12 in which the general-purpose printing program 41 transmits the generated print data to the printer 2 is an example of the "print process".

For example, when the auxiliary program 42 does not have a rasterization function, the auxiliary program 42 may cause the general-purpose printing program 41 to rasterize the intermediate data. By causing the general-purpose printing program 41 to rasterize, the auxiliary program 42 executes fewer processes, resulting in a smaller program size.

Further, instead of transmitting the print data from the general-purpose printing program 41 to the printer 2, the auxiliary program 42 may transmit the print data and a print command instructing execution of printing to the printer 2, for example, using communication according to the MIB. For example, if the print settings include a setting related to image processing that can be performed by the printer 2, such as settings and passwords for stored printing, the auxiliary program 42 may generate a print command including information on the processing.

The printer 2 starts printing based on the received print data (B21). When the received print data is compressed, the printer 2 decompresses the received print data and executes printing based on the decompressed print data. Since the compressed print data has a small data size, a reduction in transfer time can be expected. For example, when the received print data is compressed at a higher compression rate than when a parameter indicating that speed is prioritized is set during print setting and when a parameter indicating that image quality is prioritized is set, the transfer time can be reduced compared to when the parameter indicating that image quality is prioritized is set, and printing can be expected to be completed in a shorter time.

When the print data includes parameters for stored printing, the printer 2 does not execute printing until an input of a password or the like is received via the operation panel of the printer 2, and stores the print data in the memory. In the case of stored printing, the print data is compressed to reduce the data size. Therefore, even if the printer 2 accumulates the print data, the memory load is reduced.

On the other hand, when the received print data is not data subjected to the compression process, the printer 2 prints the received print data without performing a decompression process. For example, print data in PDF format, print data with the print command type set to text, or print data set with a parameter indicating that image quality is prioritized is likely to be transferred without compression, and the printer 2 can execute printing with the quality intended by the user.

The printer 2 notifies the general-purpose printing program 41 of information indicating the result of the print execution (B22). After the general-purpose printing program 41 transmits the generated print data to the printer 2 in B14, a result notification transmitted from the printer 2 may be received.

When the printing is completed, the printer 2 notifies the general-purpose printing program 41 of the completion of the printing in B22. In this case, the general-purpose printing program 41 notifies the editing application 43 that printing is completed, and ends the process. When the printing is completed, the printer 2 may not notify the general-purpose printing program 41 of the completion of the printing. In this case, the general-purpose printing program 41 operates on the assumption that the printing is completed based on the completion of the transmission of the generated raster data to the printer 2.

As described above in detail, the auxiliary program 42 according to the present aspect determines a compression condition for the compression process of compressing the intermediate data based on at least one of the print setting according to the print instruction and the capability of the printer 2, and instructs the general-purpose printing program 41 to compress the intermediate data. The auxiliary program 42 acquires from the general-purpose printing program 41 the intermediate data subjected to the compression process by the general-purpose printing program 41 according to the compression conditions. The auxiliary program 42 causes the printer 2 to perform printing based on the print data generated from the acquired intermediate data. Such an auxiliary program 42 can utilize the compression function of the general-purpose printing program 41, and the processing of the auxiliary program 42 is simpler and the load on the auxiliary program 42 is reduced compared to when the auxiliary program 42 compresses intermediate data.

In addition, the auxiliary program 42 according to the present aspect can determine whether to compress the intermediate data or the compression rate depending on the print settings or the capabilities of the selected printer 2, so that appropriate control can be expected according to the print settings or the capabilities of the selected printer 2.

Each of the aspects disclosed in the present specification are merely an example, and does not limit the present invention. Therefore, various improvements and modifications can be naturally made to the technique disclosed in the present specification without departing from the gist of the present invention. For example, the device connected to the PC 1 is not limited to the printer 2, and may be any device having a printing function, such as a multi function device, a copying machine, or a fax machine. The number of printers 2 connected to the PC 1 is not limited to the illustrated example, and may be two or more.

In addition, after the print setting screen is displayed by the general-purpose printing program 41, if the user operates to change a normally used printer from another printer to the printer 2 via the OS 21, the general-purpose printing program 41 may also activate the auxiliary program 42. Furthermore, the auxiliary program 42 may be activated not only when printing is selected, but also when, for example, the printer 2 is selected as a device setting. Even in these cases, the auxiliary program 42 may be able to execute a procedure for determining and instructing the compression conditions.

In each aspect, although only the printing operations have been described in detail as the operations of the auxiliary program 42, the auxiliary program 42 may also have other roles. The program that executes the process of the above embodiment is not limited to the auxiliary program 42, but may be any program that receives an instruction from the OS 21 or the general-purpose printing program 41 when printing is performed using the general-purpose printing program 41. For example, a print workflow application (Print workflow) whose specifications have been published by Microsoft may be used.

Further, an execution timing of the auxiliary program 42 is not limited to the example in each aspect. For example, the auxiliary program 42 may perform execution in response to a direct execution instruction from the OS 21, or may be a resident auxiliary program 42. If it is resident, the auxiliary program 42 may receive an execution command and perform the above-described operations.

In any sequence diagram disclosed in each of the aspects, an execution order of a plurality of processes in any plurality of steps can be freely changed or can be executed in parallel within a range in which no contradiction occurs in a process content.

The processes disclosed in the embodiments may be executed by hardware such as a single CPU, a plurality of CPUs, an ASIC, or a combination thereof. In addition, the processes disclosed in each aspect can be implemented in various modes such as a recording medium in which a program for executing the processes is recorded, or a method.

The support program having the above configuration determines a compression condition for the compression process of compressing the intermediate data based on at least one of the print setting according to the print instruction and the capability of the printer, and instructs the general-purpose printing program to compress the intermediate data. The support program acquires from the general-purpose printing program the intermediate data subjected to the compression process by the general-purpose printing program according to the compression conditions. The support program causes the printer to perform printing based on the print data generated from the acquired intermediate data. Such a support program can utilize the compression function of the general-purpose printing program, and the processing of the support program is simpler and the load on the support program is reduced compared to when the support program compresses the intermediate data.

A device for implementing the functions of the support program, a control method, and a computer-readable storage medium storing the support program are also novel and useful.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A non-transitory computer readable storage medium storing a support program executable by a computer of an information processing device and corresponding to a printer connected to the information processing device, the information processing device being mounted with an operating system having a general-purpose printing program,
wherein the support program causes the computer to execute:
when a print instruction that is output from an application program incorporated in the information processing device and that instructs the general-purpose printing program to cause the printer to print an image is received,
a determination process of determining a compression condition based on at least one of a print setting corresponding to the print instruction and a capability of the printer;
an instruction process of instructing the general-purpose printing program to perform compression under the compression condition determined in the determination process;
an acquisition process of acquiring intermediate data representing the image to be printed according to the print instruction, in which the intermediate data subjected to a compression process by the general-purpose printing program under the compression condition instructed in the instruction process is acquired; and
a print process of causing the printer to perform printing based on print data generated from the intermediate data acquired in the acquisition process.

2. The storage medium according to claim 1,
wherein in the acquisition process, when the intermediate data includes image data, the intermediate data is acquired by compressing the image data by the general-purpose printing program under the compression condition instructed in the instruction process.

3. The storage medium according to claim 1,
wherein the compression condition determined in the determination process includes a first condition indicating whether to compress, and
wherein in the acquisition process, when the compression condition includes the first condition indicating that compression is to be performed, the intermediate data subjected to a compression process by the general-purpose printing program is acquired, and when the compression condition includes the first condition indicating that compression is not to be performed, the intermediate data not subjected to a compression process is acquired.

4. The storage medium according to claim 3,
wherein in the determination process, when a parameter indicating that image quality is prioritized is set in the print setting corresponding to the print instruction, the first condition is determined to be not to compress.

5. The storage medium according to claim 3,
wherein in the determination process, when a parameter indicating stored printing is set in the print setting corresponding to the print instruction, the first condition is determined to be to compress.

6. The storage medium according to claim 3,
wherein in the acquisition process, when the intermediate data includes image data, the intermediate data is acquired by compressing the image data by the general-purpose printing program under the compression condition instructed in the instruction process, and
wherein in the determination process, when a parameter indicating that a type of print content is text is set in the print setting corresponding to the print instruction, the first condition is determined to be not to compress.

7. The storage medium according to claim 3,
wherein in the determination process, when memory capacity of the printer is smaller than a first threshold value, the first condition is determined to be to compress.

8. The storage medium according to claim 3,
wherein in the acquisition process, when the intermediate data includes image data, the intermediate data is acquired by compressing the image data by the general-purpose printing program under the compression condition instructed in the instruction process, and
wherein in the determination process, when a format of the print data compatible with the printer is PDF, the first condition is determined to be to compress.

9. The storage medium according to claim 8,
wherein in the determination process, when a format of the print data received by the printer is raster data, the first condition is determined to be not to compress, and
wherein in the print process, when the first condition is determined to be not to compress in the determination process, the print data generated from the intermediate data acquired in the acquisition process is compressed using a compression method compatible with the printer, and a process is performed to cause the printer to print based on the compressed print data.

10. The storage medium according to claim 1,
wherein the compression condition determined in the determination process includes a second condition indicating a compression rate, and
wherein in the acquisition process, when the compression condition includes the second condition, the intermediate data subjected to a compression process by the general-purpose printing program according to a compression rate specified in the second condition is acquired.

11. The storage medium according to claim 10,
wherein in the determination process, when a parameter indicating that image quality is prioritized is set in the print setting corresponding to the print instruction, the second condition is determined to be a first compression rate, and when a parameter indicating that speed is prioritized is set, the second condition is determined to be a second compression rate that is higher than the first compression rate.

12. The storage medium according to claim 10,
wherein in the determination process, the smaller memory capacity of the printer, the higher a compression rate determined as the second condition.
